(19) United States
(12) Patent Application Publication
(10) Pub. No.: US 2014/0260901 A1
(43) Pub. Date: Sep. 18, 2014

(54) Learning System and Method

(71) Applicant: Zachary Lasko, Rockville, MD (US)

(72) Inventor: Zachary Lasko, Rockville, MD (US)

(21) Appl. No.: 13/803,732

(22) Filed: Mar. 14, 2013

(51) Int. Cl. G09B 15/00

(52) U.S. Cl. CPC G09B 15/00
USPC 84/470 R

(57) ABSTRACT

A system of learning through practice of rhythmic activities includes detectors that receive sounds from a musical instrument and convert the sounds to a response signal, a sensory device that is activated in response to a cuing signal that cues a student to play the musical instrument, a processor to control the cuing signal of the sensory device, receive the response signal, and analyze the response signal to determine a score based on a skill level of the student, and a storage device to store the response signal and the score of the student.

### TECHNICAL FIELD

The invention relates generally to a system and method for enhancing learning capacity and improving neuromotor skills

### BACKGROUND

Development of neuromotor coordination can be enhanced through the use of rhythmic activities, such as for example, through training with a musical instrument. This type of training can be challenging, particular for children with learning or attention disabilities.

An instructor works with a student an exercise and to provide feedback. The instructor can help the student, maintain focus, recognize errors, and to suggest exercises to improve in specific areas and to set a course of instruction that is commensurate with skill level.

Hiring a qualified music instructor, particularly one that is experience with learning disabilities, can be expensive and time constraints may limit instructor availability. A student practicing alone may lose the ability to focus or become bored if the exercise only involves reading sheet music. Practicing alone can also cause a student at any level to repeat errors or to reinforce bad habits. Even with an instructor, some errors may also be hard to identify. Thus, a need exists for a rhythmic learning system that helps a student maintain focus while measuring progress.

### SUMMARY

In one general aspect, a system for learning to play a musical instrument includes detectors that receive sounds from a musical instrument and convert the sounds to a response signal, a sensory device that is activated in response to a cuing signal that cues a student to play the musical instrument, a processor to control the cuing signal of the sensory device, receive the response signal, and analyze the response signal to determine a score based on a skill level of the student, and a storage device to store the response signal and the score of the student.

Embodiments may include one or more of the following features. For example, the processor may analyze the response signal to measure various parameters such as the timing between the cuing signal and the response signal and the accuracy of the response to the cuing signal.

As another feature, the musical instrument may be a drum set with several percussion instruments such as a snare drum, bass drum and cymbals. In this embodiment, the processor analyzes the response signal to measure the multitasking ability of the student to simultaneously play more than one percussion instrument in response to the cuing signal, the velocity of the student reaction by measurement of the impact level of the response to the cuing signal, and the motor movement ability of the student by measurement of the time between playing each percussion instrument in response to the cuing signal.

The processor may analyze the score of the student to select a practice program for the student to drill one or more skill that includes timing, accuracy, velocity, multitasking ability and motor movement ability. The processor may compare a score to one or more earlier score to produce a progress result. The processor may also analyze the score of the student to select a practice program for the student.

The sensory device may be lights that illuminate to cue the student. As another feature, the sensory device produces a tactile sensation such as vibration.

In another general aspect, a method of assisting a student learn to play a musical instrument includes cuing, via a sensory device, the student to play the musical instrument, detecting a sound played on the musical instrument in response to the cuing, converting the detected sound to a response signal, measuring the response signal against a reference signal to produce a score based on a skill level of the student, and selecting a practice program based on the score of the student.

Embodiments may include one or more of the above or following features. For example, the method may include comparing a score of the student to one or more previous score to produce a progress report.

### BRIEF DESCRIPTION OF THE DRAWINGS

FIG. 1 schematically illustrates components of the invented system;

FIG. 2 is a schematic representation of the first use of the system—creation of an account and initial testing;

FIG. 3 schematically shows the work flow of the system;

FIG. 4 explains different styles of work the system allows;

FIG. 5 shows a formal structure of a work session;

FIG. 6 shows a visual representation of the results available in the system;

FIG. 7 represents different applications in the system—samples of the games available;

FIG. 8 shows skills which can be improved by using the system;

FIG. 9 represents a brief description of the skills;

FIG. 10 shows more detailed description of the skills which can be trained with the system—timing, accuracy, multitasking, and motor movement;

FIG. 11 shows a possible way of measuring velocity;

FIG. 12 shows a possible way of measuring velocity and accuracy at the same time;

FIG. 13 is a description of the Color Matching game;

FIG. 14 is a description of the Simon Says game;

FIG. 15 is a description of the Notation game;

FIG. 16 is a description of the Composer Mode;

FIG. 17 is a description of the Jam-Along game;

FIG. 18 is a description of the Race Car game;

FIG. 19 shows a structure of the databases used for storing personal user information;

FIG. 20 shows a structure of the database used for storing N top results of the user;

FIG. 21 shows a structure of the database for storing the results of the current custom style training session; and

FIG. 22 shows a structure of the database for storing the results of the current course learning style session;

### DETAILED DESCRIPTION

The system 10 can be used in many different fields such as to serve as a training system for musicians of different levels of proficiency, for testing musicians, for special needs to work on coordination, or just for entertainment. The system 10 eliminates the necessity of a teacher/special personnel, as it can be used for direct interaction with a user 12 (with light 20, sound 22, tactile actions 24, voice, etc.) and be fully adjustable for user's needs. Different kinds of instruments 14 can be used to work with the system 10. One of the applications is using the system 10 with a drum set 94, but it is not limited to this one instrument.

The system 10 is very flexible, it has many adjustable settings, for example it allows choosing the skills 80 which the user 12 wants to train in the current work session. The system 10 can also automatically create the training sessions for the user based on his previous results. FIG. 1 shows a training system 10. A User 12 works with instruments 14, and through sensors 16 a computer 18 gets the user's actions. Computer 18 interacts with the user 12 with lights 20, which can be shown on the computer 18 screen or on the instrument 14 itself. Also a computer—user interaction can be realized through sound 22, and tactile stimulation 24. The results 26 are formed after each session and include report on the user's progress, storing user's data in different databases 60 and, possibly, generation of a new work session based on the current results.

The work with the system 10 starts with a creation of an account 28 for each new user 12, as shown on FIG. 2. Initial tests 30 should be completed after a creation of an account 28 in order to define the levels of the user 12 in all available skill areas 80. They will be used later as a reference point for the first automatically generated session and also for comparing next sessions' results and for possible entering new high scores in the top results database. Additional user's personal information can be requested (such as age, gender, medical conditions, level of education, etc.) in order to be able to create comparison charts/graphs with other users with similar conditions.

Working with the system 32 shown on FIG. 3 starts with login 33 into the user's account. The user can choose the style of using the system. Two styles are available—a course learning style 36 and a custom style 38. The custom style allows the user to select any possible settings 40 and levels of difficulty to play training sessions. The user chooses a game 44 and plays it 46. The results can be stored in the special custom database 50, or in the general database 48 if desired by the user 12 or just left unsaved. For the course learning style 36 the user 12 is more limited in the options to choose from, for example, a user is not allowed to choose the level of difficulty, which is defined automatically by the system based on the previous user's results. The user has to play the session 42 that is generated by the system. The results are stored in the database 48 after every session to keep track of the user's progress. In the course learning style the user still can choose the skills 80 to work on during the current session, and the session will be generated automatically with taking into an account the user's preferences. After a session is completed the user's results for each skill trained can be seen, as well as the results of all previous sessions 52 in a representation shown on FIG. 6. The results always show the scores for all skills 80 separately, as well as the final (aggregate) score for a day. The percentage of the time spent on working on each of the skills 80 can be also seen. The comparison of the user's results with other users' results 54 is available if desired.

More detailed description of different styles of work with the system is shown on FIG. 4. The formal structure of a session 56 presented on FIG. 5, where input data (log in 32, settings 34, and hits 64) and output data 58 after playing games 62 are shown. After finishing a session all the scores are calculated as well as the number of points earned. The number of points shows the progress of a user 12 for the current session—for each of the skills 80 trained a user gets a point and double points if the score is entered in the top results database. The user's results can be stored in different databases 60 depending on the style of the work with the system.

There are applications/games 66 in the system shown on FIG. 7: the Color Matching game 68, the Simon Says game 70, the Notation Game 72, the Composer Mode 74, the Jam-Along game 76, and the Race Car game 78. There are also skills 80 which can be worked on using the invented system shown on FIG. 8: timing 82, accuracy 84, velocity 86, multitasking 88, and motor movement 90. Each game is associated with some number of skills 80 (it is also depends on the settings of a game, for example, “time delay” parameter with “one-hand-play” setting chosen will be associated with a motor movement skill 90, but with “two hands—two feet” setting will be more associated with multitasking 88).

A brief description of the skills 80 is given in the table on FIG. 9, but the system 10 can be easily expanded by adding skills 80 along with the new games/applications 66. Somewhat more detailed description of the measurement of the timing 82, accuracy 84, motor movement 90, and multitasking 88 skills is shown on FIG. 10. Measuring velocity 86 may be more challenging and more depends on the instruments 14 chosen to work with the invented system 10. An example shown on FIG. 11, illustrates measuring velocity 86 when a drum set 94 is a part of the system 10. The 0/1 sensors can be used. Then the number of sensors 16 affected will determine the strength of a strike. The strength of the vibration is different depending on the segment/area 92 of the drum 94 that was hit. For each segment 92 there will be different numbers of sensors 16 affected even with the same hardness of a strike. In order to measure the velocity 86 the number of sensors 16 affected within the segment should be counted.

If the sensors 16 attached to the drum 94 allow measuring the force of the strike, then the data showing velocity 86 will be taken from the closest to the hit area 92 sensor 16 (the sensor with the maximum value).

Measuring velocity 86 and accuracy 84 can be done at the same time, an example with a drum set 94 is shown on FIG. 12. A user 12 should hit exactly in the place where the sensor 16 is located—it allows simultaneous measuring velocity 86 and accuracy 84. It is also possible to use the multiple sensors 16.

In the Color Matching game 68 (FIG. 13) the user 12 should hit the part of an instrument 14 he/she works with, which corresponds to the color flashing. The metronome element can be added with the color flashing on the downbeat and the strike of the corresponding part of an instrument 14 on the offbeat. Timing 82 can be measured as a reaction time needed for the user 12 to strike; accuracy 84—as the hitting the correct part; velocity 86—as measuring the correct strength of a strike; multitasking 88 (if setting for “two-hands-two feet” was chosen)—as ability to use different parts of the body simultaneously; and motor movement 90 (if setting for “one-hand” was chosen)—as ability to quickly change the position of the body when reaching different parts of instruments 14 using just one hand with a help of the movements of the body for that.

In the Simon Says game 70 (FIG. 14) the user 12 chooses a sequence from the pre-made ones or enters a new one to be played with the lights flashing along with the music. The user 12 should play back the sequence as close to the sequence given as possible. The architect mode for choosing a sequence may be selected—then the next sequence is generated automatically based on the previous sequence. Timing 82 is measured as the deviation in intervals between the notes; accuracy 84, velocity 86, multitasking 88, and motor movement 90 are measured exactly as in the Color Matching game 68.

The purpose of the Notation game 72 (FIG. 15) is to teach a user 12 the musical notation. Black/color or black and color notes (depending on the settings) will flash on the screen. The user must strike the corresponding instruments 14 to activate the next note. Notes can progress from single notes to combined single strikes to sequences of both. All the skills' scores can be measured the same way as in the Color Matching game 68.

The Composer mode 74 (FIG. 16) allows the user 12 to compose its own musical pieces. With every strike, the corresponding musical note is placed on the staff. Notes are color-coordinated with the instrument 14. After creating a piece the user 12 can play back the notes as recorded on the staff. All the skills 80 are measured as in the Simon Says game 70. A musical piece can also be saved in the system and downloaded later for the other applications/games 66.

The Jam-Along game 76 (FIG. 17) allows a user 12 to download song packages with classical or popular songs or self-created musical pieces from the Composer Mode 74. The user 12 can play along with the selected music piece, playing the Color Matching game 68, the Simon Says game 70, or the Notation game 72. The skills 80 trained in this game depend on the settings chosen. Generally this game is for the use by more advanced musicians who can follow long sequences. The speed can be adjusted for the user's needs.

The Race Car game 78 (FIG. 18) is a visual representation of the competition between a user 12 and his opponent online (or a previously played game by an online user or the user's own previous games) or between a user 12 and a computer 18 (with a possibility of a level selection). The cars race across the screen on a multicolored track. Each colored section corresponds with a colored instrument 14 and depending on which section the car is on, a user 12 must strike that instrument or a combination of the instruments. The closer they are to the beat with their strikes, the faster the car moves. The track can also be black and rest above a staff notation where a sequence is shown that must be played by the user. The more accurate the user repeats the sequence the faster his car moves. The skills 80 can be measured in the ways similar to the other games, depending on the settings.

There is some number of databases needed to store all the information 60. The personal information and main personal settings of the user can be stored as shown on FIG. 19. The database for the top results of the user is shown on FIG. 20. The separate databases for a custom style of the sessions 38 and a course learning style of the sessions 36 should be created as shown on FIG. 21 and FIG. 22.

1. A learning system, comprising:
one or more detector that receives sound from a musical instrument and converts the sound to a response signal;
a sensory device that is activated in response to a cuing signal that cues a student to play the musical instrument;
a processor to control the cuing signal of the sensory device, receive the response signal, and analyze the response signal to determine a score based on a skill level of the student; and
a storage device to store the response signal and the score of the student.

2. The system of claim 1, wherein the processor analyzes the response signal to measure:
the timing between the cuing signal and the response signal.

3. The system of claim 1, wherein the processor analyzes the response signal to measure:
the accuracy of the response to the cuing signal.

4. The system of claim 3, wherein:
the musical instrument comprises a drum set with more than one percussion instrument; and
the processor analyzes the response signal to measure
the multitasking ability of the student to simultaneously play more than one percussion instrument in response to the cuing signal,
the velocity of the student reaction by measurement of the impact level of the response to the cuing signal, and
the motor movement ability of the student by measurement of the time between playing each percussion instrument in response to the cuing signal.

5. The system of claim 1, wherein the processor analyzes the score of the student to select a practice program for the student to drill one or more skill that includes timing, accuracy, velocity, multitasking ability and motor movement ability.

6. The system of claim 1, wherein the processor compares a score to one or more earlier score to produce a progress result.

7. The system of claim 1, wherein the processor analyzes the score of the student to select a practice program for the student.

8. The system of claim 1, wherein the sensory device comprises more than one light.

9. The system of claim 1, wherein the sensory device produces a tactile sensation.

10. A method of learning, comprising:
cuing, via a sensory device, the student to play the musical instrument;
detecting a sound played on the musical instrument in response to the cuing;
converting the detected sound to a response signal;
measuring the response signal against a reference signal to produce a score based on a skill level of the student; and
selecting a practice program based on the score of the student.

11. The method of claim 10, further comprising comparing a score of the student to one or more previous score to produce a progress report.

12. A method of learning with a plurality of percussion instruments, comprising:
cuing, via a sensory device, the student to play one or more of the percussion instruments;
detecting a sound played on a selected percussion instrument in response to the cuing;
converting the detected sound to a response signal;
analyzing the response signal to determine
timing between the cuing and the response signal,
accuracy of playing the selected percussion instrument in response to the cuing,
multitasking ability of the student to simultaneously play more than one of the percussion instruments in response to the cuing signal,
motor movement ability of the student by measurement of the time between playing each selected percussion instrument in response to the cuing,
measuring a sound level of the detected sound played on the selected percussion instrument;
identifying errors in the analyzed timing, accuracy, multitasking ability, motor movement ability and measured sound level;
producing an error report of the identified errors; and
selecting a practice program based on the error report.

13. The method of claim 12, further comprising comparing the error report to a previous error report to produce a progress report.

14. The method of claim 12, wherein cuing via a sensory device cuing with one or more light embedded in the percussion instruments.
